(19) United States
(12) Patent Application Publication
(10) Pub. No.: US 2019/0144595 A1
(43) Pub. Date: May 16, 2019

(54) ALKOXYLATED LIGNIN FOR POLYURETHANE APPLICATIONS

(71) Applicant: Hexion Inc., Columbus, OH (US)

(72) Inventors: Anthony Maiorana, Louisville, KY (US); Srirama N. Maddipatla Venkata, San Diego, CA (US); Ganapathy Viswanathan, Louisville, KY (US)

(73) Assignee: Hexion Inc.

(21) Appl. No.: 15/812,494

(22) Filed: Nov. 14, 2017

(51) Int. Cl. C08G 18/64; C08G 18/72; C08G 18/75; C08G 18/76; C08K 5/00; C08H 7/00

(52) U.S. Cl. CPC C08G 18/6492; C08G 18/728; C08G 18/755; C08G 2101/0025; C08G 18/7657; C08K 5/0066; C08H 6/00; C08G 18/7621

(57) ABSTRACT

Disclosed is a process comprising: a) forming a reaction mixture containing at least one polyisocyanate and a polyisocyanate-reactive compound comprising at least one alkoxylated lignin dispersion; and b) curing the reaction mixture to form a polymer.

### FIELD OF THE INVENTION

This invention relates to processes for making polymers from polyisocyanates and polyisocyanate-reactive materials. In particular, this invention relates to alkoxylated lignin useful as polyisocyanate-reactive materials.

### BACKGROUND OF THE INVENTION

The polyurethane industry currently sources the majority of its crosslinkers from petroleum-based polyols such as polyester polyols, aromatic polyester polyols, polyether polyols, and, to a lesser extent, novolacs. Lignin is an attractive crosslinker for polyurethanes because it is sustainable, contains aromatic groups that can provide rigidity and fire retardance, and is multifunctional, which allows for fast curing and highly crosslinked networks. However, lignin has not been able to be used as a polyurethane crosslinker because it is difficult to keep in solution with typical polyurethane crosslinkers and it does not behave as a thermoplastic. Therefore, development of a way to use lignin to manufacture polyurethanes would be desirable.

Alkoxylation of lignin through traditional alkoxylation routes such as ethylene oxide and propylene oxide have occurred, but these routes require specialized pressure reactors and lead to significant oligomerization of the end product and can reduce rigidity of polyurethane foams. Also, bulk alkoxylation of lignin through alkylene carbonates can result in an uncontrollable release of carbon dioxide and can present a foaming hazard during scale-up. Bulk charging can also present a challenge in the dispersion of lignin if a partial alkoxylation or minimal alkoxylation is preferred and can result in a slurry which is difficult to stir. Therefore, a safe and efficient way for alkoxylating lignin which can influence lignin molecular weight, control carbon dioxide evolution rates, and minimize oligomerization side reactions would be desirable.

### SUMMARY OF THE INVENTION

In one broad embodiment of the present invention, there is disclosed a process comprising, consisting of, or consisting essentially of: a) forming a reaction mixture containing at least one polyisocyanate and a polyisocyanate-reactive compound comprising at least one alkoxylated lignin dispersion; and b) curing the reaction mixture to form a polymer.

### DETAILED DESCRIPTION OF THE INVENTION

Lignin is a biopolymer which binds cellulose and hemicellulose together to help provide structural rigidity to plants and also acts as a protective barrier against fungi. Compositions vary, but generally lignins are cross-linked phenolic polymers with a weight average molecular weight range between 1,000-20,000 grams/mole and are notoriously difficult to process once separated from cellulose during the pulping process. Lignin is typically burned to power the boilers of a pulping plant and is otherwise considered to have limited value.

Any suitable lignin can be used in the present invention. Examples include, but are not limited to lignosulfonate (obtained via the sulfite pulping process), kraft lignins (lignin obtained via the kraft process), pyrolytic lignins (lignin obtained via the pyrolysis process), steam explosion lignin (lignin obtained via the use of steam under high pressure), organosolv lignins (lignin obtained via the organosolv process), soda-ash lignins, dilute acid lignin (lignin obtained via treatment with dilute acids), biorefinery lignin (lignin obtained from any non-pulping process which converts biomass to other chemicals), and combinations thereof.

The lignin is dispersed into an alcohol-containing compound to form a lignin dispersion. The term ‘lignin dispersion,’ as used herein, is any dispersion of lignin in a solvent. An alcohol-containing compound is any compound having one or more hydroxyl group per molecule. The alcohol-containing compound typically has a boiling point in the range of 120° C. to 300° C. In various embodiments, the alcohol-containing compound can have a boiling point in the range of from 150° C. to 250° C. Any suitable alcohol-containing compound can be used. Examples include, but are not limited to ethylene glycol, diethylene glycol, triethylene glycol, propylene glycol, dipropylene glycol, glycerol, dimethoxy glycol, and combinations thereof.

The lignin is generally added to the alcohol-containing compound at a temperature in the range of from 25° C. to 150° C. Any and all temperatures between 25° C. and 150° C. are included herein and disclosed herein; for example, the lignin can be added to the alcohol-containing compound at a temperature in the range of from 35° C. to 135° C., from 50° C. to 120° C. or from 75° C. to 105° C.

In various embodiments, a suitable basic compound can be added before or after adding the lignin to the alcohol-containing compound. Examples include, but are not limited to sodium hydroxide, potassium hydroxide, magnesium hydroxide, calcium hydroxide, barium hydroxide, lithium hydroxide, sodium carbonate, potassium carbonate, triethanol amine, triethyl amine, melamine, benzoguanidine, diethanol amine, hexamethylene diamine, ethylene diamine and combinations thereof. If the lignin dispersion is already alkaline (defined as having a pH of 8 to 14), a basic compound does not need to be added.

In various embodiments, after the lignin is added to the alcohol-containing compound, the components (along with a basic compound, if applicable) can be mechanically agitated for a period of time in the range of from 0.25 hours to 24 hours at any temperature between 120° C. and 200° C. Any and all periods of time between 0.25 hours to 24 hours are included herein and disclosed herein; for example, the components can be mechanically agitated for a period of time in the range of from 3 hours to 20 hours, from 7 hours to 17 hours, or from 10 hours to 15 hours.

The lignin dispersion generally has a lignin to alcohol-containing compound weight ratio in the range of from 1:0.3 to 1:6. Any and all ratios in the between 1:0.3 and 1:6 are included herein and disclosed herein; for example the ratio of lignin to alcohol-containing compound can be in the range of from 1:0.5 to 1:5, 1:0.5 to 1:4, 1:0.7 to 1:3, or from 1:1 to 1:2.

The lignin dispersion is reacted with an alkylene carbonate or mixture of alkylene carbonates to form the alkoxylated lignin dispersion.

The lignin dispersion is generally present in the reaction mixture in the range of from 10 weight percent to 80 weight percent, based on the total weight of components in the reaction mixture. Any and all weight percent ranges between 10 weight percent and 80 weight percent are included herein and disclosed herein; for example, the lignin dispersion can be present in the reaction mixture in the range of from 20 weight percent to 70 weight percent, from 25 weight percent to 60 weight percent, or from 30 weight percent to 50 weight percent. Any suitable reaction vessels can be used, in various embodiments, the vessel can be a batch reactor, a continuous reactor, or a semi-continuous to batch reactor.

The alkylene carbonate can be a variety of alkylene carbonates. Mixtures of alkylene carbonates can also be used. The general structure of an alkylene carbonate is represented by Formula I, below:

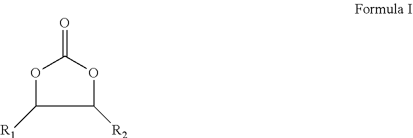

In Formula I, R₁ and R₂ are each independently a hydrogen atom, an alkyl group having 1 to 4 carbon atoms, a vinyl group, or an alkyl hydroxy group with 1 to 4 carbon atoms.

The alkylene carbonate can also be a six-membered structure, as represented by Formula II, below:

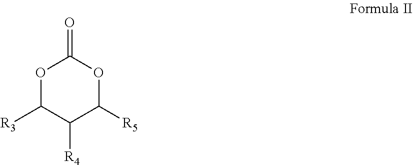

In Formula II, R₃, R₄, and R₅ are each independently a hydrogen atom, an alkyl group having 1 to 4 carbon atoms, a vinyl group, or an alkyl hydroxy group with 1 to 4 carbon atoms.

Examples of alkylene carbonates that can be used include, but are not limited to ethylene carbonate, propylene carbonate, butylene carbonate, glycerin carbonate, vinyl ethylene carbonate, and combinations thereof.

The alkylene carbonate is present in the reaction mixture in the range of from 20 weight percent to 90 weight percent, based on the total weight of components in the reaction mixture. Any and all ranges between 20 weight percent and 90 weight percent are included herein and disclosed herein; for example, the alkylene carbonate can be present in the reaction mixture in the range of from 35 weight percent to 80 weight percent, from 40 weight percent to 70 weight percent, or from 45 weight percent to 60 weight percent.

At this stage, an additional basic compound can be used in the reaction of the lignin dispersion with the alkylene carbonate to generate an alkoxylated lignin. The basic compounds that can be used are those described above. If the reaction mixture is already alkaline, then adding an additional basic compound is optional.

The basic compound is generally present in the reaction mixture in an amount in the range of from 0.25 weight percent to 5 weight percent, based on the total weight of the components in the reaction mixture. Any and all ranges between 0.25 weight percent and 5 weight percent are included herein and disclosed herein; for example, the basic compound can be present in the reaction mixture in an amount in the range of from 0.5 weight percent to 3.5 weight percent, from 1 weight percent to 3 weight percent, or from 1.5 weight percent to 2.5 weight percent.

In various embodiments, the alkylene carbonate can be added to the lignin dispersion/catalyst mixture over a period of time in the range of from 0.25 hours to 12 hours. Any and all ranges between 0.25 hours to 12 hours are included herein; for example, the alkylene carbonate can be added to the lignin dispersion/catalyst mixture over a period of time in the range of from 0.5 hours to 10 hours, from 2 hours to 8 hours, or from 3 hours to 6 hours.

In various embodiments, the components in the reaction mixture can be reacted for a period of time in the range of from 0.25 hours to 24 hours. Any and all periods of time between 0.25 hours to 24 hours are included herein and disclosed herein; for example, the components can be mechanically agitated for a period of time in the range of from 3 hours to 20 hours, from 7 hours to 17 hours, or from 10 hours to 15 hours.

In various embodiments, the alkoxylation reaction can optionally be neutralized with any mineral or organic acid. Examples of acids that can be used include but are not limited to hydrochloric acid, sulfuric acid, phosphoric acid, nitric acid, oxalic acid, formic acid, acetic acid, trifluoroacetic acid, methane sulfonic acid, and p-toluenesulfonic acid.

After alkoxylation, in order to achieve a desired, predetermined viscosity value, 40 weight percent to 90 weight percent of the alcohol-containing compound is removed from the dispersion. Any and all weight percents between 40 and 90 weight percent are included herein and disclosed herein; for example, 45 to 80 weight percent of the alcohol-containing compound can be removed, or 55 to 80 weight percent of the alcohol-containing compound can be removed.

The alcohol-containing compound can be removed from the alkoxylated lignin dispersion in any suitable manner. In various embodiments, the alcohol-containing compound can be removed by distillation.

After removal of the alcohol-containing compound, the alkoxylated lignin dispersion generally contains from 40 weight percent to 80 weight percent of solids. Any and all ranges between 40 and 80 weight percent are included herein and disclosed herein; for example, the alkoxylated lignin dispersion can have from 50 to 75 weight percent of solids, or from 55 to 70 weight percent of solids.

If desired, a different polyisocyanate-reactive compound can be added to the alkoxylated lignin dispersion in order to reduce the dispersion's viscosity. Examples of polyisocyanate-reactive compounds include, but are not limited to polyether polyols, polyester polyols, and Mannich base polyols. The polyisocyanate-reactive compound can be present in the alkoxylated lignin dispersion in the range of from 5 weight percent to 30 weight percent, from 8 weight percent to 25 weight percent, or from 10 weight percent to 20 weight percent, based on the total weight of the alkoxylated lignin dispersion.

The alkoxylated lignin of this invention can be used as polyisocyanate-reactive compounds to make polyurethanes and polyisocyanurate-based polymers.

In various embodiments, a reaction mixture is formed with at least one alkoxylated lignin and at least one polyisocyanate. Examples of polyisocyanates that can be used include, but are not limited to m-phenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotoluene diisocyanate, naphthylene-1,5-diisocyanate, methoxyphenyl-2,4-diisocyanate, diphenylmethane-4,4′-diisocyanate, 4,4′-biphenylene diisocyanate, 3,3′-dimethoxy-4,4′-biphenyl diisocyanate, 3,3′-dimethyl-4,4′-biphenyl diisocyanate, 3,3′-dimethyldiphenylmethane-4,4′-diisocyanate, 4,4′,4″-triphenyl methane triisocyanate, a polymethylene polyphenylisocyanate, polymeric diphenylmethane diisocyanate (PMDI), isophorone diisocyanate, toluene-2,4,6-triisocyanate and 4,4′-dimethyldiphenylmethane-2,2′,5,5′-tetraisocyanate. In various embodiments, the polyisocyanate is diphenylmethane-4,4′-diisocyanate, diphenylmethane-2,4-diisocyanate, hexamethylene-1,6-diisocyanate, isophorone diisocyanate, toluene-2,4-diisocyanate, toluene-2,6-diisocyanate or mixtures thereof. Diphenylmethane-4,4′-diisocyanate, diphenylmethane-2,4-diisocyanate and mixtures thereof are generically referred to as MDI and all can be used. Toluene-2,4-diisocyanate, toluene-2,6-diisocyanate and mixtures thereof are generically referred to as TDI and all can be used.

Any of the foregoing polyisocyanates can be modified to include urethane, urea, biuret, carbodiimide, allophonate, uretonimine, isocyanurate, amide, or like linkages. Examples of modified isocyanates of these types include various urethane group and/or urea group-containing prepolymers and so-called ‘liquid MDI’ products and the like.

In various embodiments, the polyisocyanate can be a blocked isocyanate, where a standard polyisocyanate is prereacted with a blocking agent containing active hydrogen groups, which can then be deblocked at temperatures greater than 40° C. (typically in the range of from 100° C. to 190° C.). Examples of blocking agents include, but are not limited to γ-caprolactam, phenol, methyl ketone oxime, 1,2,4-triazole, and dimethyl malonate.

Other polyols which can be used in conjunction with the alkoxylated lignin as polyisocyanate-reactive compounds include polyether polyols. These are prepared by polymerizing an alkylene oxide onto an initiator compound that has multiple active hydrogen atoms. Suitable initiator compounds include, but are not limited to alkylene glycols, glycol ethers, glycerine, trimethylolpropane, sucrose, glucose, fructose, ethylene diamine, hexamethylene diamine, diethanolamine, monoethanolamine, piperazine, aminoethylpiperazine, diisopropanolamine, monoisopropanolamine, methanol amine, dimethanol amine, and toluene diamine.

Polyester polyols can also be used as part of the polyisocyanate-reactive compound. Polyester polyols include reaction products of polyols, usually diols, with polycarboxylic acids or their anhydrides, usually dicarboxylic acids or dicarboxylic acid anhydrides. The polycarboxylic acids or anhydrides can be aliphatic, cycloaliphatic, aromatic, and/or heterocyclic.

Mannich base polyols, which are synthesized from Mannich bases, can also be used as part of the polyisocyanate-reactive compound.

In various embodiments, the alkoxylated lignin is present in the polyisocyanate-reactive compound in a range of from about 5 weight percent to about 50 weight percent. Any and all ranges between 5 and 50 weight percent are included herein and disclosed herein; for example, the alkoxylated lignin can be present in the polyisocyanate-reactive compound in a range of from 7 weight percent to 40 weight percent, from 10 weight percent to 30 weight percent, or from 15 weight percent to 25 weight percent.

Optionally, in various embodiments, the polyisocyanate and alkoxylated lignin mixture can also include a catalyst. Examples of catalysts include, but are not limited to tertirary amines such as dimethylbenzylamine, 1,8-diaza(5,4,0)undecane-7, pentamethyldiethylenetriamine, dimethylcyclohexylamine, and triethylene diamine. Potassium salts such as potassium acetate and potassium octoate can also be used as catalysts.

Depending upon the particular type of polymer being produced and the necessary attributes of the polymer, a wide variety of additional materials can be present during the reaction of the polyisocyanate compound with the alkoxylated lignin. These materials include but are not limited to surfactants, blowing agents, cell openers, fillers, pigments and/or colorants, dessicants, reinforcing agents, biocides, preservatives, fragrances, antioxidants, flame retardants, and the like.

If a flame retardant is included, the flame retardant can be a phosphorus-containing flame retardant. Examples of phosphorus-containing flame retardants include, but are not limited to triethyl phosphate (TEP), triphenyl phosphate (TPP), trischloropropylphosphate, dimethylpropanephosphate, resorcinol bis(diphenylphosphate) (RDP), bisphenol A diphenyl phosphate (BADP), and tricresyl phosphate (TCP), dimethyl methylphosphonate (DMMP), diphenyl cresyl phosphate and aluminium diethyl phosphinate.

The relative amounts of polyisocyanate and polyisocyanate reactive compound are selected to produce a polymer. The ratio of these components is generally referred to as the ‘isocyanate index’ which means 100 times the ratio of isocyanate groups to isocyanate-reactive groups provided by the alkoxylated lignin dispersion. The isocyanate index is generally at least 50 and can be up to 1000 or more. Rigid polymers such as structural polyurethanes and rigid foams are typically made using an isocyanate index of from 90 to 200. When flexible or semi-flexible polymers are prepared, the isocyanate index is generally from 70 to 125. Polymers containing isocyanurate groups are often made at isocyanate indices of at least 180, up to 600 or more.

To form the polymer, the polyisocyanate compound and the polyisocyanate reactive compound are mixed and cured. The curing step is achieved by subjecting the reaction mixture to conditions sufficient to cause the polyisocyanate compound and polyisocyanate reactive compound to react to form the polymer.

The polymer formed by the process of this invention can generally have a cream time in the range of from 3 percent to 10 percent lower than a polyurethane composition that was not prepared with an alkoxylated lignin, and from 4 percent to 9 percent lower in various other embodiments. The polymer can also have a gel time in the range of from 15 percent to 20 percent lower than a polyurethane composition that was not prepared with an alkoxylated lignin, and from 16 percent to 18 percent lower in various other embodiments. Additionally, the polymer can have a rise time in the range of from 5 percent to 30 percent lower than a polyurethane composition that was not prepared with an alkoxylated lignin, and from 6 percent to 26 percent lower in various other embodiments. Also, the polymer can have a tack-free time in the range of from 7 percent to 30 percent lower than a polyurethane composition that was not prepared with an alkoxylated lignin, and from 9 percent to 25 percent in various other embodiments.

A wide variety of polymers can be made in accordance with the invention through the proper selection of particular alkoxylated lignins, particular polyisocyanates, the presence of optional materials as described below, and reaction conditions. The process of the invention can be used to produce polyurethane and/or polyisocyanurate polymers of various types, including polyurethane foams, sealants and adhesives (including moisture-curable types), hot-melt powders, wood binders, cast elastomers, flexible or semi-flexible reaction injection molded parts, rigid structural composites, flexible polyurethane foams, binders, cushion and/or unitary backings for carpet and other textiles, semi-flexible foams, pipe insulation, automotive cavity sealing, automotive noise and/or vibration dampening, microcellular foams such as shoe soles, tire fillers and the like. These polymers can then be used to manufacture articles.

### EXAMPLES

For the following examples, the data was derived in accordance with the following procedures:

Zero shear viscosity was determined by utilizing a shear sweep experiment on an ARES G2 rheometer (TA Instruments) equipped with 25 mm disposable stainless steel parallel plates at a gap of 1 mm. The shear rate was swept from 1-100 l/s and the zero shear viscosity was determined by averaging the Newtonian region of the viscosity curve. The Newtonian region of the viscosity curve is determined by viscosity remaining within a 2 Pa·s region i.e. 100 Pa·s+/−2 Pa·s. Ten data points were measured for every magnitude change of shear rate such as 10 points between 0.1 and 1 l/s.

Glass transition temperature (T_{g}) was determined from a Discovery differential scanning calorimeter (TA Instruments). Samples were about 5-7 mg and sealed in hermetic aluminum pans. A heating ramp program was used and temperature was swept from −80-200° C. at a heating rate of 10° C./minute. The glass transition temperature was determined from the first heating scan through a midpoint analysis of the first inflection point of the heating curve.

### Example 1: Synthesis of Alkoxylated Lignin (Sodium Lignosulfonate:Ethylene Carbonate=1:1)

50 grams of sodium lignosulfonate, 125 grams of diethylene glycol, and 6 grams of potassium carbonate were charged to a reactor and were mechanically agitated at 140° C. for a period of 20 minutes under reflux. The temperature was raised to 175° C. and 50 grams of ethylene carbonate was charged to the lignin dispersion over a period of 30-45 minutes. The reactants were refluxed at 180° C. until the CO₂ evolution ceased. The reaction was then neutralized to a pH between 6 and 8 with 38% phosphoric acid. The reaction mixture was vacuum distilled to obtain a target viscosity between 1-30 Pa·s.

### Example 2: Synthesis of Alkoxylated Lignin (Sodium Lignosulfonate:Ethylene Carbonate=1:2)

50 grams of sodium lignosulfonate, 125 grams of diethylene glycol, and 6 grams of potassium carbonate were charged to a reactor and were mechanically agitated at 140° C. for a period of 20 minutes under reflux. The temperature was raised to 175° C. and 100 grams of ethylene carbonate was charged to the lignin dispersion over a period of 30-45 minutes. The reactants were refluxed at 180° C. until the CO₂ evolution ceased. The reaction was neutralized with 38% phosphoric acid to a pH between 6 and 8. The reaction mixture was vacuum distilled to obtain a target viscosity between 1-30 Pa·s.

### Example 3: Synthesis of Alkoxylated Lignin (Sodium Lignosulfonate:Ethylene Carbonate=1:3)

50 grams of sodium lignosulfonate, 125 grams of diethylene glycol, and 6 grams of potassium carbonate were charged to a reactor and were mechanically agitated at 140° C. for a period of 20 minutes under reflux. The temperature was raised to 175° C. and 150 grams of ethylene carbonate was charged to the lignin dispersion over a period of 30-45 minutes. The reactants were refluxed at 180° C. until the CO₂ evolution ceased. The reaction was neutralized with 38% phosphoric acid to a pH between 6 and 8. The reaction mixture was vacuum distilled to obtain a target viscosity between 1-20 Pa·s.

### Example 4: Synthesis of Alkoxylated Lignin (Sodium Lignosulfonate:Ethylene Carbonate=1:4)

50 grams of sodium lignosulfonate, 125 grams of diethylene glycol, and 6 grams of potassium carbonate were charged to a reactor and were mechanically agitated at 140° C. for a period of 20 minutes under reflux. The temperature was raised to 175° C. and 200 grams of ethylene carbonate was charged to the lignin dispersion over a period 30-45 minutes. The reactants were refluxed at 180° C. until the CO₂ evolution ceased. The reaction was neutralized with 38% phosphoric acid to a pH between 6 and 8. The reaction mixture was vacuum distilled to obtain a target viscosity between 1-20 Pa·s.

### Example 5: Synthesis of Alkoxylated Lignin (Sodium Lignosulfonate:Ethylene Carbonate=1:6)

50 grams of sodium lignosulfonate, 125 grams of diethylene glycol, and 6 grams of potassium carbonate were charged to a reactor and were mechanically agitated at 140° C. for a period of 20 minutes under reflux. The temperature was raised to 175° C. and 300 grams of ethylene carbonate was charged to the lignin dispersion over a period of 30-45 minutes. The reactants were refluxed at 180° C. until the CO₂ evolution ceased. The reaction was neutralized with 38% phosphoric acid to a pH between 6 and 8. The reaction mixture was vacuum distilled to obtain a target viscosity between 1-20 Pa·s.

### Example 6: Synthesis of Alkoxylated Lignin (Kraft Lignin:Ethylene Carbonate=1:3)

70 grams of kraft lignin, 145 grams of diethylene glycol, and 4.3 grams of potassium carbonate were charged to a reactor. The reactor is connected to dean-stark apparatus to distill the water from the kraft lignin and were mechanically agitated at 140° C. for a period of 60 minutes under reflux. The temperature was raised to 175° C. and 210 grams of ethylene carbonate was charged to the lignin dispersion over a period of 30-45 minutes. The reactants were refluxed at 180° C. until the CO₂ evolution ceased. The reaction was neutralized with 38% phosphoric acid to a pH between 6 and 8. The reaction mixture was vacuum distilled to obtain a target viscosity between 1-20 Pa·s.

### Example 7: Synthesis of Alkoxylated Lignin (Pyrolytic Lignin:Ethylene Carbonate=1:3)

50 grams of pyrolytic lignin, 125 grams of diethylene glycol, and 3.25 grams of potassium carbonate were charged to a reactor and were mechanically agitated at 140° C. for a period of 20 minutes under reflux. The temperature was raised to 175° C. and 150 grams of ethylene carbonate was charged to the lignin dispersion over a period of 30-45 minutes. The reactants were refluxed at 180° C. until the CO₂ evolution ceased. The reaction was neutralized with 38% phosphoric acid to a pH between 6 and 8. The reaction mixture was vacuum distilled to obtain a target viscosity between 1-20 Pa·s.

### Example 8: Synthesis of Alkoxylated Lignin (Sodium Lignosulfonate:Ethylene Carbonate=1:2) with Peroxide Treatment

50 grams of sodium lignosulfonate, 141.5 grams of diethylene glycol, and 3.5 grams of potassium carbonate were charged to a reactor and were mechanically agitated at 140° C. for a period of 20 minutes under reflux. The reaction mixture was cooled to 100° C. and hydrogen peroxide solution (30%, 1 g) was added the temperature was held at 100° C. for 30 minutes. The pH of the reaction mixture is adjusted by adding more potassium carbonate to a pH of 9.0. The temperature was raised to 175° C. and 100 grams of ethylene carbonate was charged to the lignin dispersion over a period of 30-45 minutes. The reactants were refluxed at 175-180° C. until the CO₂ evolution ceased. The reaction was neutralized with 38% phosphoric acid to a pH between 6 and 8. The reaction mixture was vacuum distilled to obtain a target viscosity between 1-20 Pa·s.

### Example 9: Synthesis of Alkoxylated Lignin (Kraft Lignin:Propylene Carbonate=1:3)

70 grams of kraft lignin, 125 grams of diethylene glycol, and 4.3 grams of potassium carbonate were charged to a reactor. The reactor is connected to dean-stark apparatus to distill the water from the kraft lignin and were mechanically agitated at 140° C. for a period of 60 minutes under reflux. The temperature was raised to 175° C. and 210 grams of propylene carbonate was charged to the lignin dispersion over a period of 30-45 minutes. The reactants were refluxed at 180° C. until the CO₂ evolution ceased. The reaction was neutralized with 38% phosphoric acid to a pH between 6 and 8. The reaction mixture was vacuum distilled to obtain a target viscosity between 1-20 Pa·s.

### Example 10: Synthesis of Alkoxylated Lignin (Sodium Lignosulfonate:Propylene Carbonate=1:3)

50 grams of sodium lignosulfonate, 125 grams of diethylene glycol, and 3.5 grams of potassium carbonate were charged to a reactor and were mechanically agitated at 140° C. for a period of 20 minutes under reflux. The temperature was raised to 175° C. and 150 grams of propylene carbonate was charged to the lignin dispersion over a period of 30-45 minutes. The reactants were refluxed at 180° C. until the CO₂ evolution ceased. The reaction was neutralized with 38% phosphoric acid to a pH between 6 and 8. The reaction mixture was vacuum distilled to obtain a target viscosity between 1-20 Pa·s.

### Example 11: Synthesis of Alkoxylated Lignin (Sodium Lignosulfonate:Ethylene Carbonate=1:1)

40 grams of ethylene glycol and 3 grams of 50% sodium hydroxide were charged to a reactor, mechanically agitated, and heated to 100° C. 50 grams of sodium lignosulfonate were added over 20 minutes to the ethylene glycol/sodium hydroxide solution at 100° C. under reflux mode. The resulting dispersion was then heated to 140° C. and held for 1 hour. The dispersion was then heated to 175° C. and 50 grams of ethylene carbonate was added over 1 hour and the mixture was refluxed for 5 hours at 175° C. until the CO₂ evolution ceased. The reaction product was neutralized to a pH between 6 and 8. The reaction mixture was vacuum distilled to obtain a target viscosity between 1-30 Pa·s and discharged from the reactor.

### Example 12: Synthesis of Alkoxylated Lignin (Sodium Lignosulfonate:Ethylene Carbonate=1:1)

40 grams of ethylene glycol and 3 grams of 50% sodium hydroxide were charged to a reactor, mechanically agitated, and heated to 100° C. 50 grams of sodium lignosulfonate were added over 20 minutes to the ethylene glycol/sodium hydroxide solution at 100° C. under reflux mode. The resulting dispersion was then heated to 140° C. and held for 1 hour. The dispersion was then heated to 175° C. and 50 grams of ethylene carbonate was added over 1 hour and the mixture was refluxed for 5 hours at 175° C. until CO₂ evolution ceased. The reaction product was then neutralized to a pH between 6 and 8 with 38% phosphoric acid. The reaction product was vacuum distilled to obtain a target viscosity between 1-30 Pa·s. The alkoxylated lignin was then placed back into reflux mode and 30 grams of Terate 5350 was added to further adjust the viscosity to between 1-10 Pa·s.

Tables 1 and 2 show viscosity and glass transition temperature results for some of the examples above.

TABLE 1
Viscosity and Glass Transition Temperature
of Alkoxylated Lignosulfonate

| | Lignosul- | | | | |
|---|---|---|---|---|---|
| | fonate:Ethylene | | | Viscosity | |
| | Carbonate | Catalyst | Appear- | at 70° C. | T_{g} |
| Composition | Ratio | (wt %) | ance | (Pa · s) | (° C.) |
| Example 1 | 1:1 | 6.4 | Solid | 180 | −14 |
| Example 2 | 1:2 | 5.0 | Paste | 44 | −36 |
| Example 3 | 1:3 | 3.9 | Liquid | 1.06 | −46 |
| Example 4 | 1:4 | 3.5 | Liquid | 0.93 | −51 |
| Example 5 | 1:6 | 2.7 | Liquid | 0.146 | <−75 |

As noted in Table 1, when the amount of the ethylene carbonate reactant increases, both the viscosity and the glass transition temperature of the resuling alkoxylated lignosulfonate decrease.

TABLE 2
Properties of Various Types of Alkoxylated Lignin

| Composition | | | Viscosity at | |
|---|---|---|---|---|
| (Lignin:Alkylene | Catalyst | Appear- | 70° C. | T_{g} |
| Carbonate) 1:3 | (wt %) | ance | (Pa · s) | (° C.) |
| Lignosulfonate - | 3.5 | Paste | 1.06 | −46 |
| Example 3 | | | | |
| Kraft Lignin - | 3.0 | Paste | 3.962 | −42 |
| Example 6 | | | | |
| Pyrolytic Lignin - | 2.4 | Paste | 2.086 | −47 |
| Example 7 | | | | |

As can be seen in Table 2, minor changes in viscosity and glass transition temperature result from using different types of lignin.

### Example 13: Effect of Introducing Alkoxylated Lignin into a Typical Polyurethane Formulation for Foams

The polyurethane mixtures were prepared using the formulations shown in Tables 3 and 4 below. The polyol components were prepared by the following method. For the Test Formulations, 7.5 parts of the alkoxylated lignin of Example 1, 26.56 parts of Jeffol S-490, 6.44 parts of glycerine, and 7.5 parts of an aromatic polyol were preheated to 120° C. and were blended by multiple agitation in the Speed Mixer DAC 400 FV (FlackTeck, Inc.) at 220 RPM until a homogeneous liquid was obtained. This polyol blend was then cooled to room temperature. The polyol blend was then combined with Lumulse POE-7, Jeffcat PMDETA, Catalyst LB, Polycat 8, TCPP, TEP, Niax L-6000, water, and n-pentane in the amounts shown in Tables 3 and 4 using a high-torque mixer (CRAFTSMAN 10-inch Drill Press, Model No. 137.219000) for 2 minutes at 3100 rpm to form the polyol component. The polyol component was immediately used for foam preparation by mixing with the isocyanate component according to the procedure below.

For the Reference Formulations, the polyol components were prepared by the method above, except that the preheating step was eliminated.

Method to Prepare Foam Samples: Foams were prepared using a high-torque mixer (CRAFSTMAN 10-Inch Drill Press, Model No. 137.219000) at 3,100 rpm speed. Polyol components and isocyanate components of the foam systems were mixed for 10 seconds. Afterwards, the mixtures were transferred into an open card boxes before the cream time and were allowed to free-rise. The foaming profile, including cream time, gel time, rise time, and tack-free time were measured on all foams as shown in Tables 3 and 4 below.

Foams were prepared with formulations selected for testing by pouring foam mix in card boxes without any liners to determine the adhesion of the foam to the card box as a substrate.

### Description of Materials:

Jeffol S-490: Sorbitol-initiated polyol, with a hydroxyl value of 490 mg KOH/g, available from Huntsman

Lumulse POE(7): Glycerine ethoxylate, with a hydroxyl value of 419.1 mg KOH/g, available from Vantage

Terol® 250: Modified aromatic polyester polyol, available from Huntsman

Aromatic polyol: Aromatic polyol with a hydroxyl value of 496 mg KOH/g

Jeffcat PMDETA: Pentamethyldiethylenetriamine catalyst, available from Huntsman

Catalyst LB: Potassium acetate catalyst

Polycat 8: Dimethylcyclohexylamine catalyst

TCPP: Trichloropropylphosphate, a flame retardant

TEP: Triethylphosphate, a flame retardant

Niax L-6900, a polysiloxane surfactant, available from Momentive Performance Materials

Rubinate 9257: a polymeric MDI available from Huntsman

Rubinate M: a polymeric MDI available from Huntsman

The reactivity differences between the two formulations are measured as the mix time, cream time, gel time, rise time and tack-free time as shown in Table 3.

TABLE 3
Formulations and Test Results for Polyurethanes

| | Reference | Test |
|---|---|---|
| | Formulation #1 | Formulation # 1 |
| Polyol component, pbw | | |
| Jeffol S-490 | 26.56 | 26.56 |
| Glycerine | 6.44 | 6.44 |
| Lumulse POE-7 | 17.2 | 17.2 |
| Terol 250 | 15 | |
| Aromatic polyol | 0 | 7.5 |
| Alkoxylated lignin | 0 | 7.5 |
| Jeffcat PMDETA | 0.25 | 0.25 |
| Catalyst LB | 0.5 | 0.5 |
| Polycat 8 | 0.15 | 0.15 |
| TCPP | 19 | 19 |
| TEP | 5 | 5 |
| Niax L-6900 | 2 | 2 |
| Water | 2.2 | 2.2 |
| n-pentane | 4 | 4 |
| Residual water | 0.082 | 0.297 |
| Isocyanate component, | | |
| pbw | | |
| Rubinate 9257 | 158.13 | 170.04 |
| Isocyanate Index | 130% | 130% |
| Reaction profile of free-rise foams | | |
| Mix time, s | 10 | 10 |
| Cream time, s | 21 | 20 |
| Gel time, s | 49 | 40 |
| Rise time, s | 70 | 52 |
| Tack-free time, s | 72 | 54 |
| Free-rise density, pcf | 2.07 | 2.42 |

It is evident from Table 3 that the alkoxylated lignin-containing formulation increases the reactivity of the system. The gel time, rise time, and tack-free time all decreased significantly.

### Physical and Mechanical Property Testing Methods:

Core Density, pcf Method: ASTM D 1622-03

Compressive Strength, psi: ASTM D 1621-00

Compressive Strain @ Yield %: ASTM D 1621-00

Friability (Mass Loss %): ASTM C 421

Burning Rate in a Horizontal Position (cm/min), ASTM D 4986 (modified)

Aging Test @ 70° C. and Ambient Humidity (Volume and Mass change %) ASTM D 2126

Aging Test @ −30° C. and Ambient Humidity (Volume and Mass change %) ASTM D 2126

Dimensional stability after 7 and 14 days with humid aging at 158° F. and 100% RH ASTM D 2126

TABLE 4
Formulations and Test Results for Polyurethanes

| | Reference | | Test | |
|---|---|---|---|---|
| | Formulation #2 | | Formulation # 2 | |
| Polyol component, pbw | | | | |
| Jeffol S-490 | 26.56 | | 26.56 | |
| Glycerine | 6.44 | | 6.44 | |
| Lumulse POE-7 | 17.2 | | 17.2 | |
| Terol 250 | 15 | | 0 | |
| Aromatic polyol | 0 | | 7.5 | |
| Alkoxylated lignin | 0 | | 7.5 | |
| Jeffcat PMDETA | 0.25 | | 0.25 | |
| Catalyst LB | 0.5 | | 0.5 | |
| Polycat 8 | 0.15 | | 0.15 | |
| TCPP | 19 | | 19 | |
| TEP | 5 | | 5 | |
| Niax L-6900 | 2 | | 2 | |
| Water | 2.2 | | 2.2 | |
| n-pentane | 4 | | 4 | |
| Residual water | 0.086 | | 0.300 | |
| Isocyanate component, pbw | | | | |
| Rubinate M | 158.43 | | 170.04 | |
| Isocyanate Index | 130% | | 130% | |
| Properties | | | | |
| Core density, pcf | 2.00 ± 0.03 | | 2.10 ± 0.08 | |
| Compressive stress at Yield, psi | 13.9 ± 1.1 | | 12.1 ± 0.7 | |
| (parallel to rise) | | | | |
| Compressive strain at Yield, % | 8.2 ± 1.0 | | 6.6 ± 1.0 | |
| (parallel to rise) | | | | |
| Compressive strength at 10% | Failed before 10% | | 5.0 ± 0.2 | |
| strain, psi (perpendicular to | | | | |
| rise) | | | | |
| Friability (mass loss %) | 4.7 | | 4.5 | |
| Burning Rate in a horizontal | Self-extinguishing | | Self-extinguishing | |
| position (cm/min) | | | | |
| Dimensional Stability- | | | | |
| Properties after 7 days (% | | | | |
| change) | Volume | Mass | Volume | Mass |
| 70° C./ambient humidity | 1.5 ± 0.3 | 0.4 ± 0.2 | 1.4 ± 0.4 | 0.1 ± 0.2 |
| −30° C./ambient humidity | 0.7 ± 0.1 | 0.0 ± 0.0 | 1.1 ± 0.3 | 0.0 ± 0.0 |
| 70° C./100% humidity | 0.8 ± 0.1 | 0.0 ± 0.0 | 0.6 ± 0.6 | 0.0 ± 0.0 |
| Dimensional Stability - | | | | |
| Properties after 14 days (% | | | | |
| change) | Volume | Mass | Volume | Mass |
| 70° C./ambient humidity | 1.5 ± 0.8 | 0.4 ± 0.2 | 1.3 ± 0.3 | 0.1 ± 0.2 |
| −30° C./ambient humidity | 1.0 ± 0.2 | 0.0 ± 0.0 | 1.1 ± 0.2 | 0.0 ± 0.0 |
| 70° C./100% humidity | 1.4 ± 0.1 | 0.0 ± 0.0 | 0.5 ± 0.6 | −0.2 ± 0.3 |

| | | |
|---|---|---|
| Adhesion to the box | Excellent | Excellent |
| Reaction profile of free-rise foams | | |
| Mix time, s | 10 | 10 |
| Cream time, s | 22 | 20 |
| Gel time, s | 60 | 50 |
| Rise time, s | 82 | 77 |
| Tack-free time, s | 87 | 79 |

As can be seen in Table 4, Test Formulation #2 containing alkoxylated lignin not only had a superior reactivity compared to Reference Formulation #2, but also resulted in a foam with a uniform cell structure, comparable friability, and good dimensional stability. Test Formulation #2 was self-extinguishing as was Reference Formulation #2. Both Reference Formulation #2 and Test Formulation #2 had compressive strain at yield values of less than 10%. Also, the difference between the compressive stress at yield values between the two formulations was not statistically significant.

While the present invention has been described and illustrated by reference to particular embodiments and examples, those of ordinary skill in the art will appreciate that the invention lends itself to variations not necessarily illustrated herein.

1. A process comprising:
a) forming a reaction mixture containing at least one polyisocyanate and a polyisocyanate-reactive compound comprising at least one alkoxylated lignin dispersion;
and
b) curing the reaction mixture to form a polymer.

2. The process of claim 1 wherein the alkoxylated lignin dispersion is prepared with a lignin selected from the group consisting of lignosulfonates, kraft lignins, pyrolytic lignins, organosolv lignins, soda-ash lignins, steam explosion lignins, dilute acid lignins, biorefinery lignins, and combinations thereof.

3. The process of claim 1 wherein the reaction mixture further comprises a flame retardant.

4. The process of claim 1 wherein the polyisocyanate is selected from the group consisting of diphenylmethane-4,4′-diisocyanate (4,4 MDI), diphenylmethane-2,4′-diisocyanate (2,4 MDI), toluene-2,4-diisocyanate, toluene-2,6-diisocyanate, isophorone diisocyanate, hexamethylene-1,6-diisocyanate, polymeric diphenylmethane diisocyanate (PMDI) and combinations thereof.

5. The process of claim 1 wherein the polymer is prepared with a polyisocyanate-reactive compound having from 5 weight percent to 50 weight percent of the alkoxylated lignin dispersion.

6. The process of claim 1 wherein the polymer has a cream time that is from 3 percent to 10 percent lower than a polymer that was not prepared with an alkoxylated lignin dispersion.

7. The process of claim 1 wherein the polymer has a gel time that is from 15 percent to 20 percent lower than a polymer that was not prepared with an alkoxylated lignin dispersion.

8. The process of claim 1 wherein the polymer has a rise time that is from 5 percent to 30 percent lower than a polymer that was not prepared with an alkoxylated lignin dispersion.

9. The process of claim 1 wherein the polymer has a tack-free time that is from 7 percent to 30 percent lower than a polymer that was not prepared with an alkoxylated lignin dispersion.

10. The process of claim 1 wherein the polymer is a rigid polyurethane foam.

11. An article prepared from the rigid polyurethane foam of claim 10.
